(19) United States
(12) Patent Application Publication
(10) Pub. No.: US 2026/0246338 A1
(43) Pub. Date: Aug. 20, 2026

(54) Rotating Electrical Machine

(71) Applicant: Astemo, Ltd., Chiyoda-ku, Tokyo (JP)

(72) Inventors: Zhi JING, Hitachinaka-shi, Ibaraki (JP); Kenichi NAKAYAMA, Hitachinaka-shi, Ibaraki (JP); Yuki KUMADA, Hitachinaka-shi, Ibaraki (JP); Noriaki HINO, Hitachinaka-shi, Ibaraki (JP)

(21) Appl. No.: 19/162,152

(22) PCT Filed: Jun. 29, 2023
(86) PCT No.: PCT/JP2023/024271

§ 371 Date: Sep. 4, 2025

(51) Int. Cl. H02K 9/19; H02K 5/20

(52) U.S. Cl. CPC H02K 9/19; H02K 5/203

(57) ABSTRACT

A rotating electrical machine includes a stator, a rotor, and a housing that encloses the stator and the rotor. The stator includes an annular stator core, and a coil inserted in the stator core, the coil having a coil end protruding outside beyond an end face of the stator core. The housing includes an annular supply path formed by a first wall and a second wall radially inside the first wall, and a discharge path that causes a medium flowing inside the supply path to be discharged towards the coil end. The discharge path is formed by an open end that is an end face of the second wall protruding towards the stator core when viewed in a cross section, and an end face of the stator core.

### TECHNICAL FIELD

The present invention relates to a rotating electrical machine.

### BACKGROUND ART

Higher-power motors require increased cooling performance. For example, a means of improving coil cooling efficiency by supplying refrigerant oil directly to the coil ends in known. For such a cooling means, PTL 1, for example, discloses a motor with a circular coolant flow path 43 defined by a notched portion 42 of a resin mold 31, an end face 3A on one side in the direction of the rotation axis O of the stator 3, and an inner circumferential surface of the housing 4. This flow path supplies the coolant to both the end face of the stator 3 and the coil ends, improving the cooling efficiency without increasing motor size.

### CITATION LIST

### Patent Literature

[PTL 1] Japanese Patent Application Publication No. 2005-354821

### SUMMARY OF INVENTION

### Technical Problem

According to the conventional technique, for the direct cooling of the coil ends using coolant, it was necessary to drill an additional discharge hole in the cooling jacket of the housing for discharging the coolant. In order to cool all the coil ends arranged in the circumferential direction of the stator, it was necessary to drill multiple discharge holes in the housing. This results in increased machining costs and reduced housing strength.

### Solution to Problem

A rotating electrical machine includes a stator, a rotor, and a housing that encloses the stator and the rotor. The stator includes an annular stator core, and a coil inserted in the stator core, the coil having a coil end protruding outside beyond an end face of the stator core. The housing includes an annular supply path formed by a first wall and a second wall radially inside the first wall, and a discharge path that causes a medium flowing inside the supply path to be discharged towards the coil end. The discharge path is formed by an open end that is an end face of the second wall protruding towards the stator core when viewed in a cross section, and an end face of the stator core.

### Advantageous Effects of Invention

The present invention can provide a rotating electrical machine that achieves cost reduction, enhanced housing strength, improved cooling performance, and size reduction.

### BRIEF DESCRIPTION OF DRAWINGS

FIG. 1 is a cross-sectional view of a motor according to one embodiment of the present invention.

FIG. 2 is an enlarged view of part A in FIG. 1.

FIG. 3 is a diagram illustrating a circumferential overview of a supply path according to one embodiment of the present invention.

FIG. 4 is an illustrative diagram of a discharge path according to one embodiment of the present invention.

### DESCRIPTION OF EMBODIMENTS

An embodiment of the present invention will be hereinafter described with reference to the drawings. The following description and drawings are examples for illustrating the present invention, with omissions and simplifications made for the sake of clarity. The present invention can be embodied in various other ways. Unless particularly specified, various constituent elements may be singular or plural.

For easier understanding of the invention, the position, size, shape, or range of various constituent elements in the drawings may not reflect the actual position, size, shape, or range. It follows that the present invention is not necessarily limited by the position, size, shape, or range disclosed in the drawings.

### One Embodiment and Overall Configuration

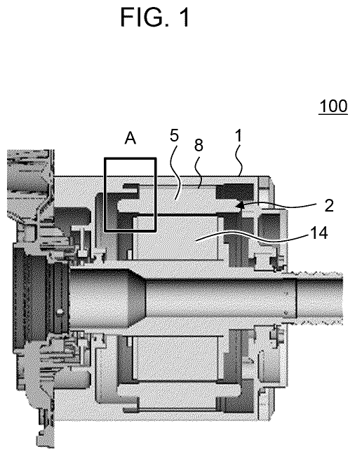

### (FIG. 1)

The motor 100 includes a rotor 14 and a stator. A housing 1 encloses the rotor 14 and the stator. The stator includes a stator core 5 and coils 2. The stator core 5 is formed in an annular shape extending in the circumferential direction and includes a plurality of slots (not shown) along the circumferential direction. The coils 2 are inserted in respective slots. A supply path 8 for cooling the stator extends in the axial direction radially outside the stator core 5.

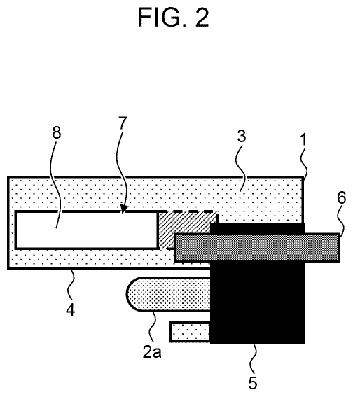

### (FIG. 2)

The coils 2 (FIG. 1) of the stator core 5 have coil ends 2a on both axial ends. The coil ends 2a protrude out of the stator core 5 beyond both axial ends of the stator core 5. The housing 1 includes a first wall 3 and a second wall 4 radially inside the first wall 3. The supply path 8 is a flow path for a coolant to flow through to cool the motor 100, and is formed by the first wall 3 and the second wall 4 in the radial direction.

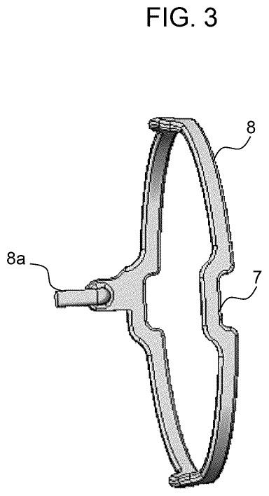

The supply path 8 is formed in an annular shape extending in the circumferential direction as shown in FIG. 3 and as will be described later. The supply path 8 extends also in the axial direction radially outside the stator core 5 (see FIG. 1), so that coolant can be supplied to both axial ends of the stator core 5.

The stator core 5 is secured to the housing 1 via fixing portions 6 and arranged to protrude into an axially extending part of the supply path 8. The fixing portions 6 are bolts, for example, and provided radially inside the first wall 3. This allows the motor 100 to be designed small.

The supply path 8 includes offset portions 7 at positions corresponding to the circumferential locations of the fixing portions 6. Thus, the supply path 8 can be formed in the circumferential direction while circumventing the fixing portions 6, which helps achieve size reduction.

### (FIG. 3)

FIG. 3 shows the supply path 8 formed in the circumferential direction in the rotating electrical machine 100. The drawing does not illustrate the axially extending part of the flow path that is radially outside the stator core 5, and the supply path 8 on the opposite side of the stator core 5 of FIG. 2. The circumferential supply path 8 is shown on its own for ease of understanding of its shape. As mentioned above, the actual supply path 8 is a space formed between the first wall 3 and the second wall 4 inside the motor housing 1.

The supply path 8 allows coolant to flow in from a coolant inlet port 8a and through the inside. The supply path 8 has the offset portions 7 that are axially offset to circumvent the fixing portions 6 along the contour of the fixing portions 6. This prevents an increase in the axial size of the rotating electrical machine 100, contributing to size reduction.

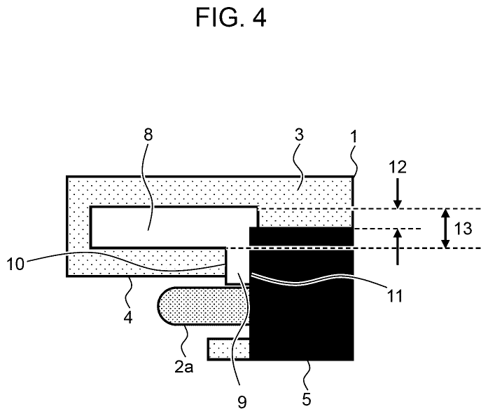

### (FIG. 4)

The supply path 8 includes a discharge path 9 that extends radially inwards. The discharge path 9 is formed to extend along the supply path 8 in the circumferential direction. The discharge path 9 is provided radially inwards and perpendicularly to the supply path 8 axially extending. Coolant is discharged towards the coil end 2a located radially inside the discharge path 9 so that the coils 2 are directly cooled.

The discharge path 9 is formed by an open end 10 that is an end face of the second wall 4 protruding towards the stator core 5 when viewed in a cross section, and a core end face 11 that is an end face of a part of the stator core 5. Although not shown, the discharge path 9 may be formed in a similar manner in the offset portions 7 of the supply path 8 (FIG. 2 and FIG. 3).

Thus, the discharge path 9 for directly cooling the coils 2 and increasing the heat dissipation efficiency is formed by the housing 1 (open end 10) and the stator core 5 (core end face 11). There is no need to drill additional holes in the housing 1. This design increases the strength of the housing 1 and contributes to cost reduction. The discharge path 9 can be designed with a high degree of freedom in areas other than the fixing portions 6 in the circumferential direction.

The stator core 5 fixed to the housing 1 by fixing portions 6 is positioned such that the distance from the first wall 3 to the outer circumferential surface of the stator core 5, i.e., first distance 12, is smaller than the second distance 13 from the first wall 3, which is the radial width of the supply path 8. This contributes to size reduction of the motor 100.

The embodiment of the present invention described above provides the following advantageous effects.
(1) The rotating electrical machine 100 includes a stator, a rotor 14, and a housing 1 that encloses the stator and the rotor. The stator includes an annular stator core 5, and a coil 2 inserted in the stator core 5, the coil having a coil end 2a protruding outside beyond an end face of the stator core 5. The housing 1 includes an annular supply path 8 formed by a first wall 3 and a second wall 4 radially inside the first wall 3, and a discharge path 9 that causes a medium flowing inside the supply path 8 to be discharged towards the coil end 2a. The discharge path 9 is formed by an open end 10 that is an end face of the second wall 4 protruding towards the stator core 5 when viewed in a cross section, and an end face 11 of the stator core 5. The rotating electrical machine 100, thus designed, offers cost reduction, enhanced housing strength, improved cooling performance, and size reduction.
(2) The first distance 12, which is a radial distance from the first wall 3 to an outer circumferential surface of the stator core 5, is smaller than the second distance 13, which is a distance from the first wall 3 to the second wall 4. This design contributes to size reduction.
(3) The discharge path 9 is provided radially inwards and perpendicularly to the supply path 8 axially extending. This design provides improved cooling effect.
(4) The rotating electrical machine includes a fixing portion 6 that fixes the stator core 5 to the housing 1. The supply path 8 includes an offset portion 7 axially offset to circumvent the fixing portion 6 along the contour of the fixing portion 6. This design contributes to size reduction.

The present invention is not limited by the embodiment described above. Various modifications or other configurations can be incorporated without departing from the scope of the subject matter. The present invention is not limited to the embodiment including all the elements described above, but also includes other versions in which some parts of the configuration are omitted.

### REFERENCE SIGNS LIST

1 Housing
2 Coil
2a Coil end
3 First wall
4 Second wall
5 Stator core
6 Fixing portion
7 Offset portion
8 Supply path
8a Coolant inlet port
9 Discharge path
10 Open end
11 Core end face
12 First distance
13 Second distance
14 Rotor
100 Motor

1. A rotating electrical machine comprising a stator, a rotor, and a housing that encloses the stator and the rotor,
the stator including an annular stator core, and a coil inserted in the stator core, the coil having a coil end protruding outside beyond an end face of the stator core,
the housing including an annular supply path formed by a first wall and a second wall radially inside the first wall, and a discharge path that causes a medium flowing inside the supply path to be discharged towards the coil end,
the discharge path being formed by an open end that is an end face of the second wall protruding towards the stator core when viewed in a cross section, and an end face of the stator core.

2. The rotating electrical machine according to claim 1, wherein
a first distance, which is a radial distance from the first wall to an outer circumferential surface of the stator core, is smaller than a second distance, which is a distance from the first wall to the second wall.

3. The rotating electrical machine according to claim 1, wherein
the discharge path is provided radially inwards and perpendicularly to the supply path axially extending.

4. The rotating electrical machine according to claim 2, further comprising
a fixing portion that fixes the stator core to the housing,
the supply path including an offset portion axially offset to circumvent the fixing portion along a contour of the fixing portion.
